(19) United States
(12) Patent Application Publication
(10) Pub. No.: US 2018/0060825 A1
(43) Pub. Date: Mar. 1, 2018

(54) SYSTEM AND METHOD FOR MANAGING APPLICATIONS IN THE CLOUD

(71) Applicant: General Electric Company, Schenectady, NY (US)

(72) Inventors: William Jeffrey DUBRUL, Houston, TX (US); Jason SCHAMP, Houston, TX (US)

(21) Appl. No.: 15/687,832

(22) Filed: Aug. 28, 2017

Related U.S. Application Data
(60) Provisional application No. 62/380,095, filed on Aug. 26, 2016.

(51) Int. Cl. G06Q 10/10

(52) U.S. Cl. CPC G06Q 10/1093

(57) ABSTRACT

This disclosure provides a method for application management including identifying a list of applications, inserting one or more automation schedules for one or more applications of the list of applications into a database, running the one or more automation schedules, identifying one or more instance activity, scheduling a time for the one or more instance activity to occur, and sending a notification to an application user, wherein the notification alerts a user to the scheduled time for the one or more instance activity and a user may choose to change the scheduled time. A system is also provided including an application management module, wherein the application management module includes a dashboard comprising one or more selectable elements for management of one or more applications, wherein application management comprises scheduling and notifying a user of one or more instance activity.

### BACKGROUND

Cloud computing has allowed infrastructure, services, software, and other instances to run on a virtualized platform. The cloud provides users with internet-based computing letting users take advantage of shared information technology resources and providing a cost-effective infrastructure. For example, data storage, resource-time sharing, processing capabilities, allocation of servers, and network bandwidth can be shared amongst many users. The shared resources allow for scalability or for a user to take advantage of expertise and knowledge in a technology field that is not their own.

Application owners increasingly have chosen to host their applications in the cloud. Applications or “apps.” are pieces of software that can run, for example, on a computer, a mobile device, an electronic device, or the Internet. Applications come in the form of packaged software programs that can be run by a user, may exist on the Internet, such as within a website or web browser window, or may be downloaded by a user to their electronic device. Application hosting can be performed on an existing cloud infrastructure, such as Microsoft's Azure, Amazon Web Services, GoGrid, Rackspace, ElasticHosts, among others, or a private cloud provided by an individual, company, or group. By hosting an application in the cloud, the application owner can reach many users who are connected to the cloud.

### SUMMARY

This disclosure relates generally to cloud computing and more specifically to managing applications hosted in the cloud. This disclosure provides a method for application management including identifying, using a module, a list of applications, inserting one or more automation schedules for one or more applications of the list of applications into a database, running the one or more automation schedules, identifying one or more instance activity, scheduling a time for the one or more instance activity to occur, and sending a notification to an application user, wherein the notification alerts a user to the scheduled time for the one or more instance activity.

This disclosure further provides a method of application management by a user by identifying an instance to change, entering a module for application management, viewing, in the module, a list of one or more activities, choosing one or more activities to run.

This disclosure provides also an application management system including an application management module, wherein the application management module includes a dashboard comprising one or more selectable elements for management of one or more applications, wherein application management comprises scheduling and notifying a user of one or more instance activity.

Various aspects of the disclosed subject matter may provide one or more of the following capabilities and technical effects. Embodiments of the system and method described herein can enable an enterprise application deployment to monitor and automate maintenance and application oversight by providing the application owner and their delegates with increased control of their applications and their infrastructure automation schedules. The system can include a self-service portal for application owners, a communication mechanism, and a scheduling mechanism. Tickets and requests to administrators can be reduced due to the increased control application owners have, and may result in a lower number of resources and touch time required, a lower amount of non-value added work in application management, and quicker changes.

Central tracking and recording of all automated actions can be improved regardless of the language. A development-operations (DevOps) culture can be enabled by having a central portal for application owners to have control over their application without full system-wide access. Systems can be kept up-to-date since maintenance activities can be automated to run within the application owner's preferred schedule, resulting in increased efficiency and cost reduction. Automated, ongoing, cost-out can be consistently identify and eliminate wasted infrastructure, reducing the need for large workouts to optimize usage. The system can automatically identify who owns which applications, eliminating the sprawl of servers without identified owners by performing destructive server elimination based on metadata or “tags.”

These and other technical effects and capabilities of the disclosed subject matter will be more fully understood after a review of the following figures, detailed description, and claims.

### BRIEF DESCRIPTION OF THE FIGURES

The following drawings are intended to show non-limiting examples of the disclosed subject matter. Other embodiments are possible.

Other objectives, features, and advantages of the present invention will become evident from the following description of the embodiments of the invention taken in conjunction with the following drawings, wherein:

FIG. 1 is a diagram depicting an exemplary cloud computing environment;

FIG. 2 is a diagram depicting an exemplary enterprise application deployment with a number of user bases;

FIG. 3 is a flowchart of an exemplary embodiment of an automated maintenance method;

FIG. 4 is a flowchart of an exemplary embodiment of a manual maintenance method;

FIG. 5 is a diagram of an exemplary application management system;

FIG. 6 is a diagram of an exemplary maintenance schedule;

FIG. 7 is an illustration of an exemplary module homepage;

FIG. 8 is an illustration of an exemplary dashboard page;

FIG. 9 is an illustration of an exemplary dashboard modules window;

FIG. 10 is an illustration of an exemplary dashboard modules window;

FIG. 11 is an illustration of an exemplary application control window;

FIG. 12 is an illustration of an exemplary activities window;

FIG. 13 is an illustration of an exemplary activities window;

FIG. 14 is an illustration of an exemplary activities window;

FIG. 15 is an illustration of a detailed view of an exemplary automation schedule control window;

FIG. 16 is an illustration of a detailed view of an exemplary automation schedule control window;

FIG. 17 is an illustration of an exemplary sort by menu;

FIG. 18 is an illustration of an exemplary applications page;

FIG. 19 is an illustration of an exemplary status menu;

FIG. 20 is an illustration of an exemplary environments page;

FIG. 21 is an illustration of an exemplary servers page;

FIG. 22 is an illustration of an exemplary note screen;

FIG. 23 is an illustration of an exemplary automation schedule control screen;

FIG. 24 is an illustration of an exemplary action selector menu;

FIG. 25 is an illustration of an exemplary automatic actions menu;

FIG. 26 is an illustration of an exemplary profile menu;

FIG. 27 depicts an exemplary chart of completed actions; and

FIG. 28 depicts an exemplary chart of active and inactive actions.

### DETAILED DESCRIPTION

Certain embodiments of the disclosed subject matter generally relate to techniques for managing maintenance and support of cloud-based computer programs. Many cloud-based computing systems can include tens, if not hundreds of applications that are managed by a single administrator. Because the single administrator can be responsible for managing all of the applications on the system, the administrator can quickly become overwhelmed by update requests from the various application owners. Likewise, in circumstances where the administrator makes a global change, this can have a negative effect on some of the applications. As discussed herein, embodiments of the disclosed subject matter can provide a secure environment where application owners themselves can access and control many aspects of their application. Some embodiments can even include automation features to automate some of the tasks and communications the application owner or administrator otherwise would be responsible for. Other embodiments are within the scope of the disclosed subject matter and provide the technical effects described herein.

Embodiments described herein are directed toward a system and method for managing applications hosted in a cloud environment where the system and method may be designed to provide interface managers or owners with increased control over their applications. Many cloud-based applications involve a single large application with thousands or millions of users. When the owner of the application requires an update, the owner may go into a cloud provider's administrator console to perform the update where the owner's application may be the only application within the system. In other instances, tens or hundreds of applications may share a system in the cloud. When an owner of one of these applications requires an update, the owner typically will submit a request to an individual, known as a cloud administrator, who has access to the system and can make the change. The application owner does not have access to the system for security reasons since applications other than their own are also accessible within the system. The system of submitting requests for updates, changes, or maintenance may not be feasible, however, for a large number of applications or enterprise applications which may involve thousands of applications being hosted in the cloud with hundreds of users each. If each application owner submits requests to an administrator, the administrator may quickly be overwhelmed by the high quantity of requests and may need to either hire costly support to perform non-value added work or cause delays in answering the requests. In other circumstances, the administrator may oftentimes make a system-wide update that is imposed in a top-down manner upon the application owner causing issues or conflicts with the application's schedule or the application owner's team schedule.

Embodiments of the subject matter described herein provide a self-service portal or module where control of an application can be provided to the application's owner and any delegates the owner identifies. Through this portal, the application owner can be provided with a secure environment where they can access and control many aspects of their application infrastructure themselves and delegate access and control to their teams without the requirement of submitting requests to another party. Embodiments of the disclosed subject matter can allow for automatic events to occur to address maintenance or update requirements without the application owner having to initiate the requests thus keeping the system up-to-date and running efficiently. In another aspect, communication can be improved and simplified by the use of automatic notifications and a sample template that can be generated by the system and which may be sent to identified or designated recipients letting them know of a scheduled activity and time. By providing the control described herein to the application owner, if an automated event is scheduled which may cause an issue or conflict with the application's schedule or the application owner's team schedule, the application owner may go into the system and shift the schedule to suit their needs while still allowing the automation to proceed at the newly scheduled time. The application owner may also develop new features and automation or modify automation to suit their needs based upon the example framework described herein. Other embodiments are within the scope of the disclosed subject matter.

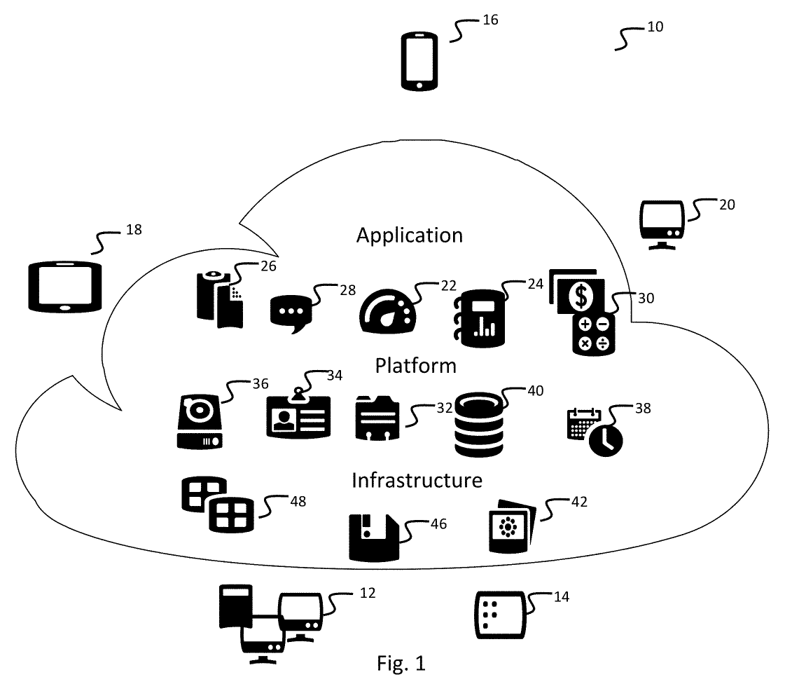

FIG. 1 illustrates a diagram of an exemplary cloud computing structure. A cloud environment 10 may be public, private, or hybrid, and may include one or more of applications, platforms, and infrastructure. For example, the cloud may house one or more applications for monitoring 22, content applications 24, collaboration applications 26, communication applications 28, finance applications 30, or industrial applications (not shown) amongst others. The cloud 10 may further include platforms such as object storage 32, identities 34, runtimes 36, queues 38, and databases 40. Infrastructure such as computers 42, block storage or memory 46, and networks 48 may also be included in the cloud 10. Outside of the cloud 10, various devices may be connected to and utilize the resources of the cloud 10, such as laptops 14, servers 12, desktops 20, tablets 18, phones 16, and industrial machines (not shown) such as turbines, healthcare machines, oil rigs, natural gas plants, among many others.

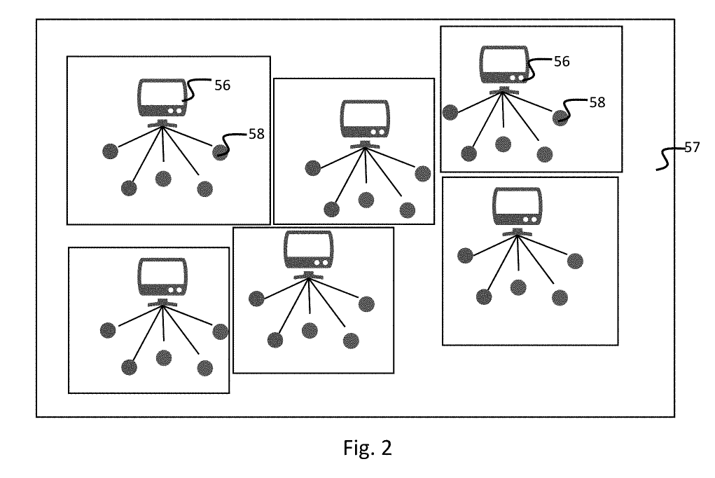

FIG. 2 is a diagram depicting an exemplary enterprise application deployment with a number of user bases. In an enterprise 57, instead of a single application that has thousands, millions, or more users, the enterprise 57 may have hundreds, thousands, or more applications 56, where each application may have 10-15 servers, with hundreds of users 58 for each application as an example. In enterprise 58, there may be a large number of diverse owners of the applications 56, where each owner has different requirements and needs for their application. For instance, an application owner may be trying to cut costs by ensuring that their application is up-to-date and that all elements of their application not in use are turned off or removed to save the cost of running that element. Another owner may want to ensure their applications are running nearly-constantly and may seek to avoid as much downtime for updates as possible. The system described herein may provide each application owner with control over their own applications and thus their own initiatives. The system may also provide a framework for the addition or enhancement of automation by others outside of the product team. For example, product owners (licensees) can develop their own automation and “plug in” to the product framework.

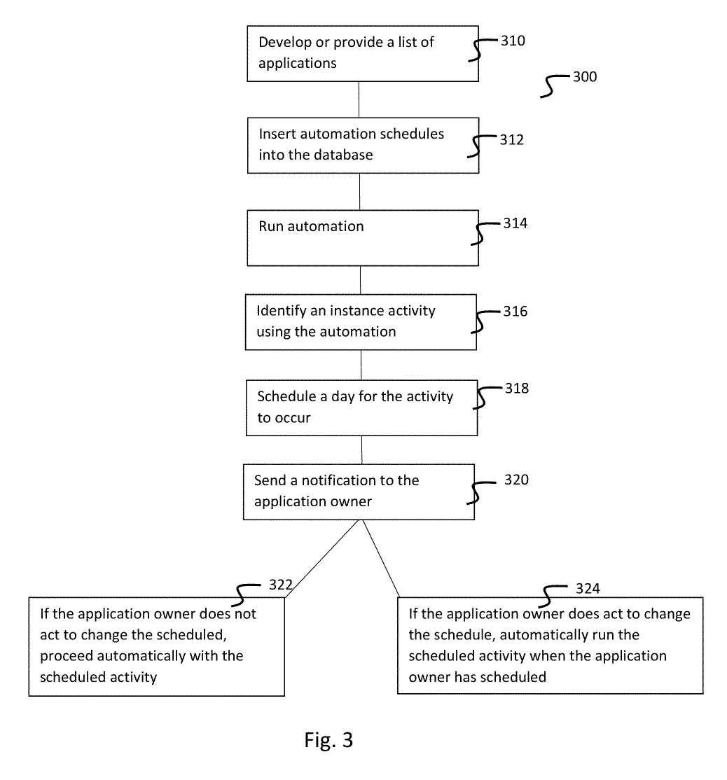

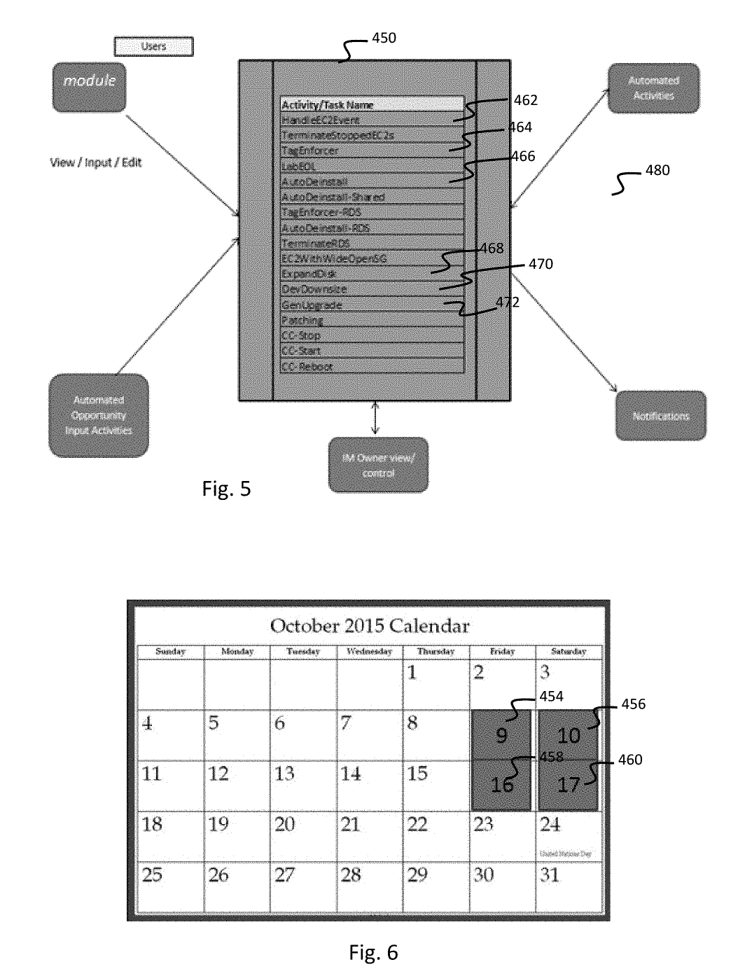

With reference to FIG. 3, a flowchart of an embodiment of an automated maintenance method 300 is shown. With reference to FIG. 5, a flowchart of an embodiment of a manual maintenance method 400 is shown. The methods 300 and 400 illustrate exemplary methods and are non-limiting. The steps of method 300 and method 400 may be altered, e.g., by having steps added, removed, or rearranged. The methods 300 and 400 may be used in conjunction with embodiments of the subject matter of the system described herein.

FIG. 3 illustrates a method which may be used to automate maintenance of the application management system. In the method 300, a master record or centralized database of all applications within an enterprise may be provided or developed at step 310. This record or database can include the name or other identifier of the application, the owner of the application, who has access to the application, and/or other information. In another embodiment, less than all applications may be included in a record of applications, for example, if a large enterprise with thousands of applications is divided into a number of smaller businesses, a master record for each business may be compiled.

From the master list, an application owner identifier, such as an employee or user name, number, login, or other owner ID may be imported from an existing system or attributed to each application. The application owner can then input the number, name, or other identifier of individuals or groups the application owner wishes to delegate access to, which can allow the application owner to retain control over who has access to the system, schedule, and activities. The delegation/access list can be changed as needed at the application owner level by the owner himself.

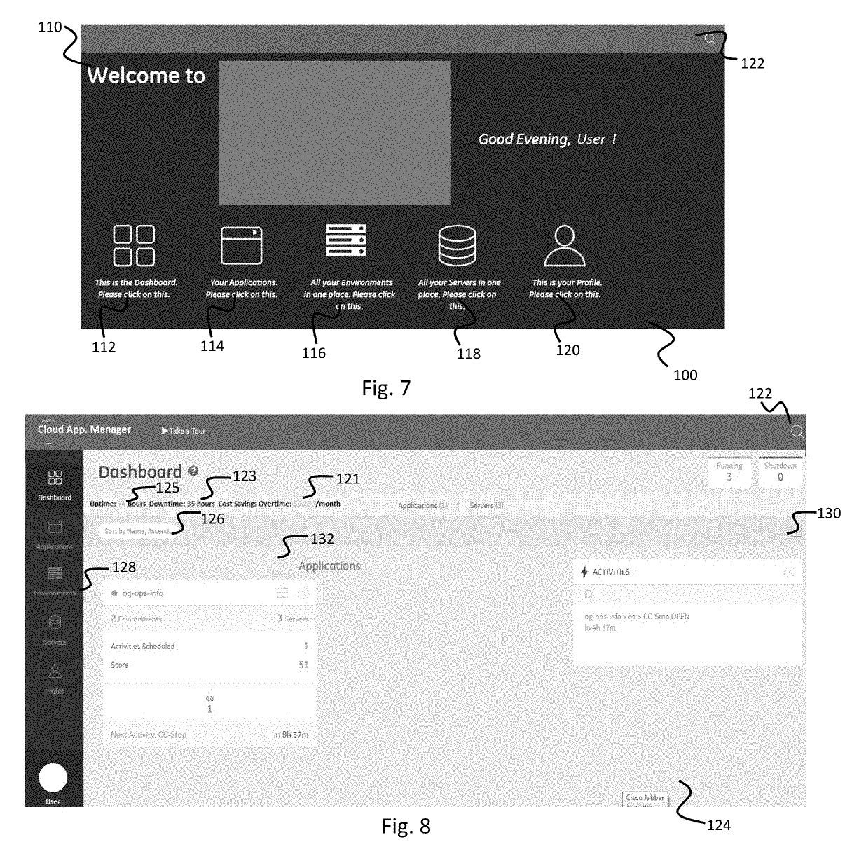

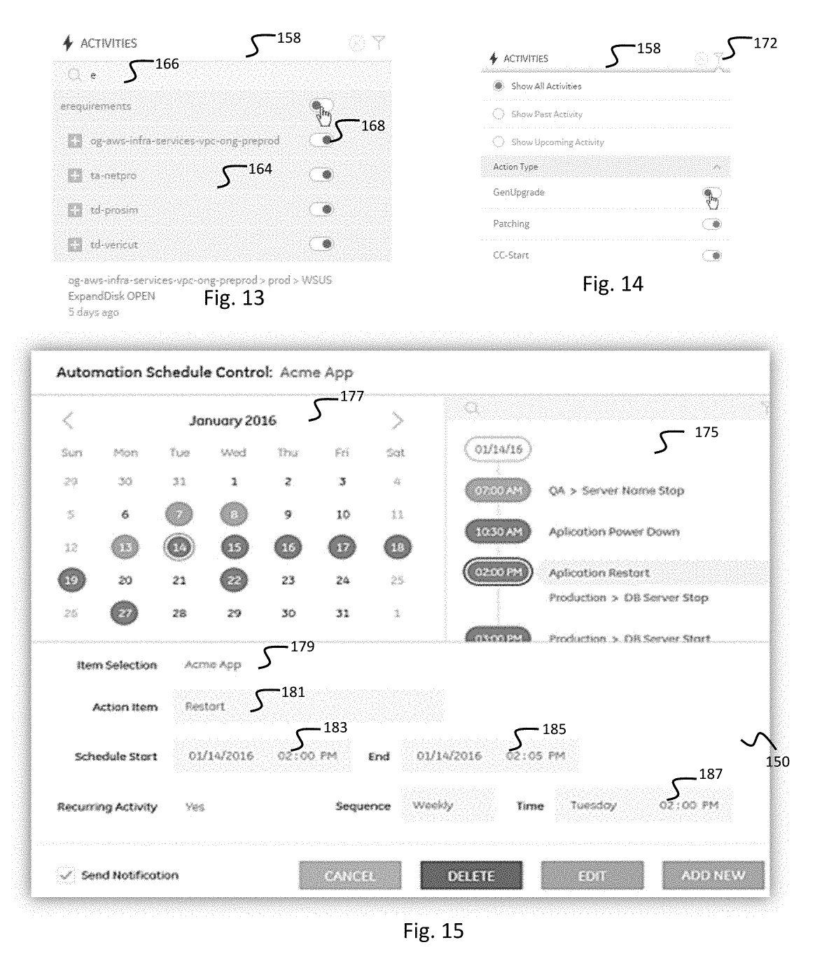

Automation schedules may be inserted into the database of applications at step 312. A user interface described in FIGS. 7-27 can allow automation and scheduled activities to be easily moved as needed. The automation code or script may be modified depending on the service provider hosting the applications or cloud provider and may not be limited to any one application host. In an embodiment, the automation runs at step 314 to identify instances, look to a schedule for the database, and to run the actions.

At step 316, automation or “bots” may be used to identify changes that could be made or recommendations for an application as instance activities. For example, a cost saving bot may be run on the first of the month to identify if an instance is undersized or not being used. This bot can run automatically and may identify instances as cost saving opportunities without generating a report that must be reviewed and acted on by a person.

In the system, the automation bot can identify an instance at step 316 and the system can automatically schedule a time and/or activity for the instance to occur at step 318. An automatic notification may be sent to the application owner informing the owner of the scheduled change at step 320. The system described herein can provide a framework for automatically determining who should receive the communication and then sends the communication. The communication system can reduce the need for administrators to manually identify who should receive the emails and then can send emails to the owners alerting them of an activity or suggested activity, which may lead to increased communication and saved administrator time.

If an application owner prefers a different time or day, a different activity, or to cancel the activity, the application owner can enter the system and select a different time or day at step 324. The chosen or scheduled activity can run at the time selected by the application owner. The owner may also choose to cancel the activity if it is incorrect or if the application owner does not want the activity to proceed. At step 322, if the application owner does nothing or takes no action, the automation can run the activity at the scheduled time.

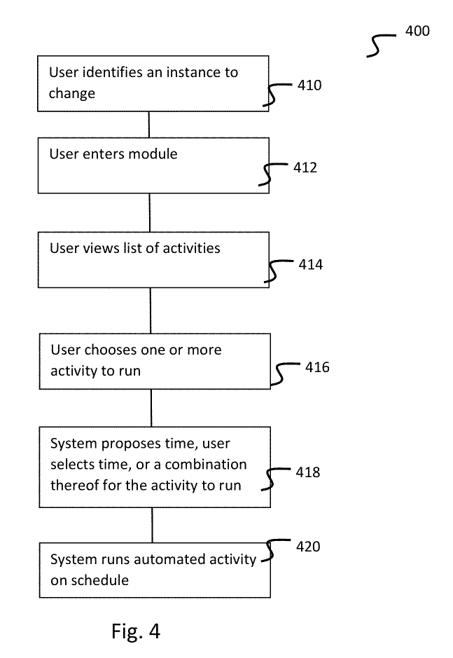

In an embodiment, illustrated in method 400 in FIG. 4, an application owner or user may choose to initiate an automation, activity, or update. At step 410, a user can identify an instance to change. For example, a user may determine that the disk size should be expanded for their application. The application owner may also input the parameters and allow the system to determine when the expansion of disk space activity can occur. At step 412, the user can enter the management module. At step 414, the user can navigate to a page to view a list of optional activities the user may select. The user may also choose to view a calendar, schedule, or list of already scheduled activities. At step 416, a user can select one or more activities to run. At step 418, the user may select a time to schedule the activity to occur. In another embodiment, the system may propose a time the activity will occur. In yet another embodiment, the system may propose a time and the user may choose to change the time. At step 420, the system runs the activity automatically at the scheduled time.

In an embodiment, an application owner may choose to go into the module to shut down any elements of their application that they are not using in a similar method to that of FIG. 4. By shutting down these elements, costs may be lowered because application owners are not paying for a service they are not using. In the current system disclosed herein, an application owner can develop a schedule where instances may automatically be shut down and come back up on the application owner's chosen schedule. Rather than an administrator scheduling the downtime without knowing an application owner's preferences or needs, the application owner himself may schedule the downtime for his application.

As an example, a user interface for developing applications may involve three environments: a development environment, a quality assurance environment, and a production environment. Once an application is running, the development and quality assurance environments are not typically needed. Therefore, if these environments are not needed or not being utilized, the application owner can shut it down himself in order to save costs and resources.

In the system, an owner can initiate any preauthorized action at the time they wish to run the action as described in method 400. The application owners may be limited by a list, such as that shown at 450 in FIG. 5. FIG. 5 also provides an overview of embodiments of the system 480. The system 480 may include one or more of a user module, automated opportunity input activities, IM owner view/control, automated activities, and notifications in addition to the list 450. The list 450 may also act as a security measure. An enterprise may choose not to allow for largely destructive actions to be included in the list depending upon the level of control delegated to the application owner. The system may also allow an application owner to take corrective action if a problem does arise. For instance, if an application owner has expanded the disk space to be bigger than it should have been, the application owner can go in and shrink the disk space. If an instance is erroneously shut down or if it should have been shut down, but now should be turned back on, the owner may go in to turn the instance back on. These activities can be scheduled directly by the owner without a cloud administrator involved and may save man-hours and cost.

Due to the limited options provided to the application owner, destruction of an entire system may be limited. In this system, an application owner does not have access to the entire cloud system console where all features and functions are available for all applications, which could be destructively wiped out. The system described herein provides a more restricted and safer console for each application owner to have control of their applications for most of their needs by providing access to an actions list 450.

With reference to FIG. 5, the sample list 450 lists options that may be available to an application owner, though a custom or customizable list may be presented and any activity that may be delegated to the application owner could be included in such a list. List 450 may not be limited to only the activities shown and may include or more less activities than those illustrated. A number of options from the list 450 shown in FIG. 6 are further described herein. A product team, administrator, customer, licensee, or other individual or group of users with access to or that uses the system and method described herein may add additional options to the list 450.

Embodiments of the system and method may provide an automation framework that enables new automation by users. The system may provide a framework, but can also allow users to expand the system and develop new features to add to the product. For example, a basic user interface and/or database may be standard or “box” features, but modifications can be made by a user of the system, to existing automation and automation the user adds to the system. Application program interface calls can be included, which can be made or used by other automation and can allow different automation languages or users with different skillsets to expand or adapt the built-in features of the system to suit the user's needs.

If the owner or system activates a HandleEC2Event 462 or similar activity shown in FIG. 5, a piece of automation may be handled by the system. An example of an event, HandleEC2Event 462, could be useful for all applications, but may be of specific use for applications bought from a vendor and intended to run in a commercial data center rather than in the cloud. An application hosting service may identify an issue with an application or instance and can shut it off and turn it on again. For applications designed for the cloud, this may be accounted for and not cause a disruption. For applications not designed for the cloud, shutting down an instance could cause damaging or unwanted effects.

The system can include automated script that reads a system queue and detects that the instance is scheduled to be shut down. The system can send a notification to the application owner with a time the system has determined may be best for the automation and schedules the automation to occur at this time. The system may be customized based upon the preference of an IT team or application owner, and can identify schedules appropriately.

For example, a company best practice may be to perform automation and maintenance on the second weekend 454, 456 and third weekend 458, 460 of the month as shown in FIG. 6. In an example, the weekend may comprise Friday and Saturday with start times of 9 PM. Development and quality assurance may occur on the second weekend 454, 456 of the month and the production may occur on the third weekend 458 and 460. If the application hosting service suggested a time outside of the noted days, the system described herein could move the schedule, using an algorithm, to fit the action to the preferred schedule. In this embodiment, it could be the more preferred schedule that is sent in a notification to the application owner, who may still retain the capability to change the schedule to their needs.

For example, originally the application may have been scheduled to shut down on Wednesday at 2:00 PM; however, the automation may select Saturday at 2:00 AM instead. If the application owner determines that the event in the notification should not proceed, the application owner may go into the system, can view the calendar and may identify the HandleEC2Event 462. The application owner may then choose to remove it from the calendar and/or reschedule for a different time, or may choose to delete the event altogether. If the user does not act, the event can proceed as scheduled.

In another embodiment, the system or an application owner may select AutoDeinstall 464 or a similar activity. By activating AutoDeinstall 464, automation may be used to identify applications that an owner has made inactive. By inactivating an application, an owner may be preparing for the application to be decommissioned. Rather than taking approximately six weeks to two months to shut down, as may have been the case in a legacy corporate datacenter, within this system, the automation can identify that an application has been made inactive and can send an email or other notification to an application owner indicating the application has become inactive. This email or other notification may indicate to the owner that no changes will be made for a time period, for example 30 days, but at the end of that time period, the application will be deleted. If the owner does not want this to occur or believes the application was incorrectly made inactive, the owner may go into the dashboard to remove the action and/or reactivate the application.

At least one benefit of AutoDeinstall 464 may be that application owners may not have to complete the deinstalliation process themselves or submit requests to do so. The owner's inactive applications may be identified and deleted without their action, which can result in cost savings opportunities being taken advantage of automatically.

In another embodiment, a user or the system may activate TagEnforcer 466 or a similar activity. This can allow managers and owners to control or enforce tagging criteria on application owners. For instance, in the centralized database or master list, the system may identify all applications, who the owners are, etc. so that costs may be allocated appropriately. If an application owner has developed an application that does not meet criteria set by the enterprise or IT team, such as who the application owner is, what applications are owned, etc. so that they can be billed correctly, a notification may be sent and the instance may be stopped. As an example, an application owner may launch an infrastructure, such as a server, that does not meet specific rules such as linking it back to applications, maintaining strict billing records, etc. The TagEnforcer 466 can detect this server and may send an email or notification to the owner, which may indicate that criteria may not have been met.

The owner may then go into the system or dashboard to view the schedule of all of their shut downs making any necessary changes. This owner control can lessen the shutting off instances on owners without their knowledge and can eliminate the need for expensive deep dives into how an application or instance was shut off without an application owner knowing. The notifications can allow for a hyperinformative environment. The notifications may eliminate the need to perform the forensic deep dives into shutdowns altogether.

In an embodiment, the system or an owner may activate ExpandDisk 468 or a similar activity. This can allow an application owner, whose disk may be filling up, to go into the schedule where they can select ExpandDisk 468, can fill out any necessary forms to determine a correct size of the disk, and can schedule a disk expansion. In another embodiment, the system may automatically identify that a disk size too big. As described above, the automation may make the identification, notify the user, and if the user does not require any changes, the automation can shrink the size of the disk resulting in cost-savings to the owner. The shrinking of the disk may be done automatically.

In an embodiment, the system or an owner may activate DevDownsize 470 or a similar activity. In this instance, the system may be designed to read performance metrics of the application hosting system or other metrics and, using formulas within the system, the system can determine if the instance may be actually being used. If certain thresholds are met, such as using a certain amount of memory, the network, etc., then it may be possible to determine that an instance is being used. If thresholds are not met, downsizing may be appropriate, which can save costs. In the system, once a downsizing opportunity is identified, a notification, that may include a template, may be sent automatically and/or manually letting the owner know a downsize would save costs and can schedule this downsize to occur. The notification may also be sent to automatically identified individuals which the system can identify. If the owner disagrees, they can go into the system to delete the activity so that it does not proceed. If the downsize is acceptable, the automation can occur and the cost saving advantages may be recognized.

In another embodiment, a user or the system may select GenUpgrade 472 or a similar activity. Many of the application hosting systems may be dynamic and may be periodically upgraded. An old version may be phased out and may be replaced with a new version. In some instances, where applications are built for the cloud, this may not be an issue because the system would remove the older version and could rebuild the newer version automatically. This may not be the case for applications not designed for a cloud, which can require a manual shut down, a change to the instance type, bringing the instance back up, testing the instance, and completing a confirmation that the new instance type is running. Keeping the instance type up to date can result in cost savings and/or more efficiency, but the process of updating can prohibitive.

In the system, upgrade opportunities can be identified automatically, a notification may be sent to a user letting them know their instances are going to run on an older version of hardware in the service system and that an upgrade may be scheduled to occur. If the application owner does not wish for the upgrade to occur or wishes to reschedule, the application owner may go into the system and cancel or remove the activity. This can allow a default to be set to update the application owner's older version automatically so that more instances may be kept up to date. Fleet-wide optimization may be achieved resulting in lower costs. If a user cancels the activity, the system may catch the upgrade opportunity the next time it runs and can again propose an update to an owner in the next round. For enterprises that move non-cloudaware applications into the cloud, this can enable automatic adoption of the latest instance generations.

FIG. 7 illustrates an exemplary user interface of an application management portal or module available to an application owner and/or their delegates. In an embodiment, an application owner can navigate into an application management module 100. The management module 100 may include a dashboard, homepage, website, webpage, or other display screen. Management module 100 may be visible on various devices within, connected to, or outside of the cloud, such as laptops 14, servers 12, desktops 20, tablets 18, phones 16. For exemplary purposes, the user interface illustrated in FIG. 7 will be referred to as a homepage 110. The homepage may include one or more interactive elements such as a dashboard icon 112, an applications icon 114, an environments icon 116, a servers icon 118, a profile icon 120, a search bar 122, among others. The interactive elements may include icons, drop down menus, clickable text or images, radial buttons, or other similar features. By selecting one or more of these icons, a user may be brought to various pages described herein. The homepage 110 and other pages described herein may also display a user greeting, a user icon or image, branding, and other customizable features.

An application owner may enter the module 100 or homepage 110 and view all of their instances or servers associated with their applications. An application owner and/or their delegates can only view the information for the applications they own or that they have been allocated access to. The application owners can delegate access through the portal and allow users, support teams, etc., who they grant access, to have access and have complete or near complete control.

FIG. 8 illustrates an exemplary landing page of a dashboard module 124. In an embodiment, the application owner can further enter the system 100 by clicking the dashboard icon 112. The application owner may be brought to a dashboard 124, which may include fixed and/or customizable elements 128. A customizable dashboard 124, for example, may present a list 132 of any application, environment, or server an application owner has access to or permission to view. An application owner may set up or customize their own dashboard 124 by selecting to display dashboard modules by clicking an icon 130. Icon 130 may represent adding an application, such as by displaying a plus sign. Alternately, icon 130 may be an icon, a dropdown menu, or other selective means.

The dashboard and any of the pages of the system described herein may also include a cost savings section 121. In an embodiment, cost saving figures may be generated by the system. The system can gather information about the instances of the applications, the efficiency, and/or the time the application is on/off as shown at 125 and 123, and from this data can determine the costs for running each application. The system can also identify cost saving measures and activities. For example, if an owner turns down instances that are not being used 25% of the time, the system can calculate the cost of the application running is 75% of what it would have been without the turn down.

The system or a user of the system may present this information in various tables, charts, documents, and other visual methods to entities such as the owners, chief information officers, managers, customers, clients, IT personnel, and others to show how much cost has been saved or spent. This can allow for easy sharing, analyzing, and exporting of data to show an impact of the activities around an application. A detailed cost sheet or bill can be provided illustrating interactive levers that can be switched on or off to predict the cost impact or system impact of any activity in the system. This option can be controlled at the application owner level and does not require an administrator to generate or oversee. An application owner may see the cost increase of increasing the size of an instance or the savings that can be achieved by lowering the size of an instance—all which may be within the application owner's control.

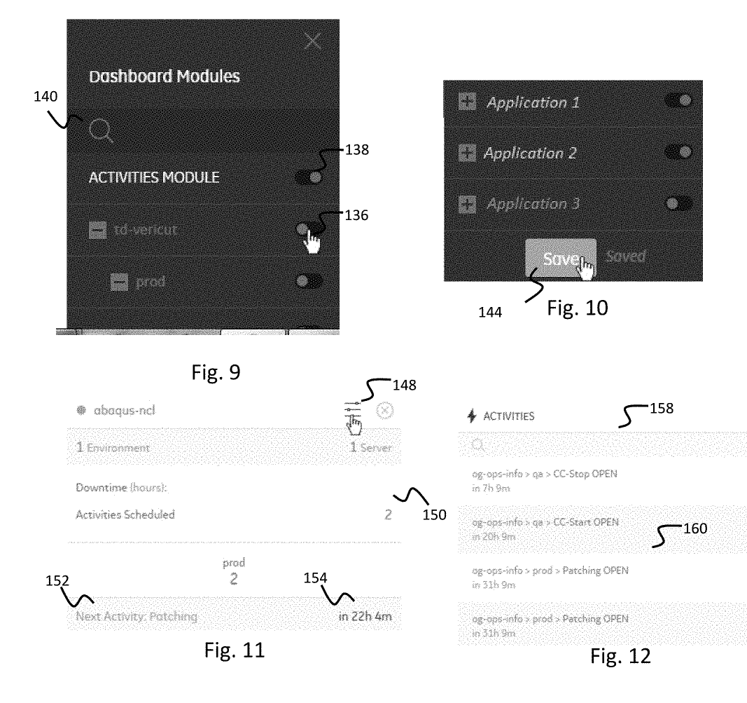

As illustrated in FIG. 9 showing a dashboard modules menu window, in an embodiment, the application owner may use a toggle switch 136, 138 for any application, environment or server they wish to add or remove from their dashboard. For instance, the application owner may use a toggle switch 138 to move a selection to a selected mode, which can allow the application, environment, or server to be visible on their dashboard. The application owner may use a toggle switch 136 to move a selection to a non-selected mode, which can hide the application, environment, and/or server from displaying. The application owner may also search for their application or other information using the search bar 140. Upon selecting the applications, environments, and/or servers an application owner would like to view on their dashboard, the application owner can save their selections by selecting the save icon 144 to keep applications or other items displayed on their dashboard 124 permanently or semi-permanently as illustrated in FIG. 10.

In an embodiment, the dashboard may include one or more of a menu, icon, or other selection means 148 for opening an automatic schedule control 150 for an application, an environment, and/or a server. As illustrated in FIG. 11, which shows a window containing detailed information about an application, each module visible in the automation schedule control 150 may display a next activity 152 or can display multiple activities if more than one activity exists in an activities window, and can display the time until the next activity is scheduled to occur 154.

In embodiments shown in FIGS. 12-14, an activities window 158 is displayed. The activities window 158 may contain up to six, ten, or more of the latest activities 160. The automatic schedule control 150 may also show past activities and/or cancelled activities. In an activities window 158, an application owner may choose to remove one or more of an application's active activities from a list of activities 164. In an embodiment, an application owner can search for an application using a search bar 166 and/or can move a toggle switch 168 to the left or right causing the activity to be removed.

As illustrated in FIG. 14, activities may also be filtered by selecting a filter option 172. The activities may be filtered by date, action type, and/or another identifier. Depending on an application owner's preference or needs, the application owner may choose to select or toggle an action type in order to show actions the application would like to view or hide an action the application owner may not wish to view. In the example shown in FIG. 14, GenUpgrade actions may not be shown since the toggle has been switched off. This option can also allow an application owner to only view the action or actions the application owner needs or wishes to view.

A more detailed view 175 of the automation schedule control 150 is provided in FIG. 15. In this view, a calendar 177 may be displayed indicating when an activity may be scheduled to occur. Colors or other markings may be viewed on or applied to the calendar to denote the days, times, and/or types of activities that are scheduled. Details about the scheduled activity, such as the time, date, application, type of activity, etc. may be provided in a display 175. The detailed view may further display one or more of an application name 179, an action item 181, a scheduled start time 183, a stop time 185, information regarding recurrence of the activity 187, and/or whether a notification should be sent. The detailed view may further display one or more options to cancel, delete, edit, or add a new automation, activity, or action item.

In an exemplary use of the automation schedule control 150, the application owner may choose to perform the activity sooner or more aggressively and the system can provide the control for them to do so, for example, in detailed view 175 of the automation schedule control 150. The system also reduces or eliminates imposed actions where possible. In certain instances, such as for security reasons or compliance, an activity must occur and the system described herein may be designed to inform the application owner. If an application owner cannot delete an activity, such as with patching instances for risk or security concerns, the application owner may be still presented with a schedule in automation schedule control 150 and can alter the schedule. For important instances, the options for the application may be limited, such as by moving the instance up a week or back a week. Alternatively, the application owners may choose to avoid the schedule altogether and perform the activity themselves earlier.

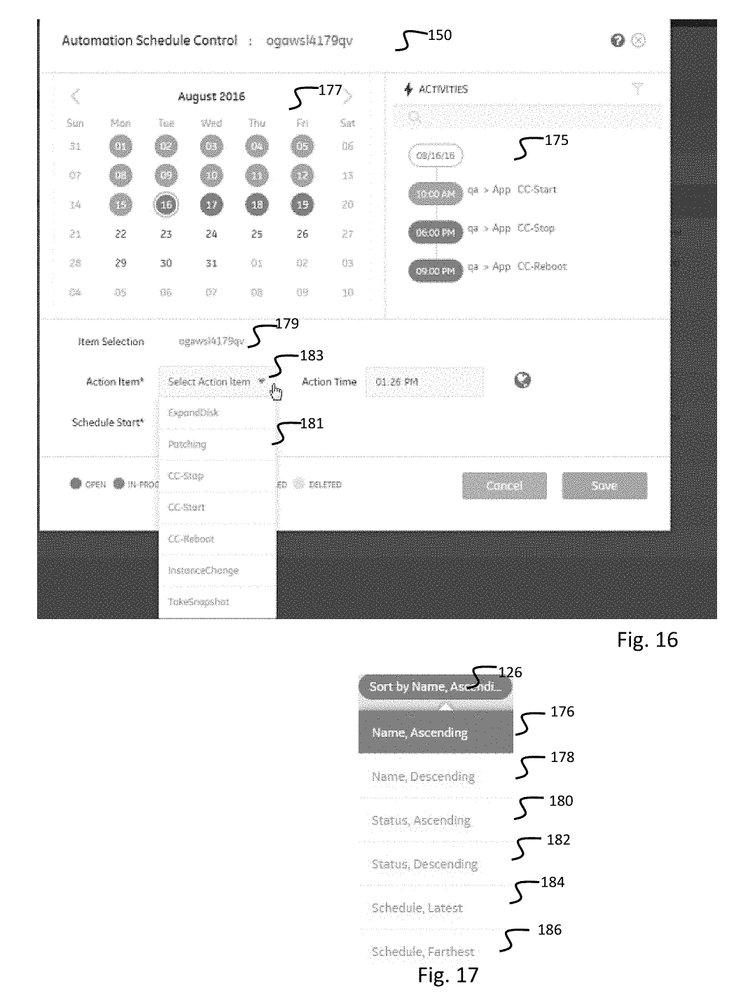

FIG. 16 illustrates an exemplary automation schedule control window. FIG. 16 shows automation schedule control 150 with the action item 181 feature selected. In this embodiment, a dropdown menu 183 may be displayed presenting a user with action items that may be selected. Such action items may include at least one of ExpandDisk, Patching, Stop, Start, Reboot, InstanceChange, TakeSnapshot, though additional or alternative action items can be included. In use, an application owner can navigate to the automation schedule control page 150, may identify an action, and can schedule the action to be completed by the automation within the system. Using automation schedule control 150, a user may schedule a time and/or activity for one or more server, one or more environment, and/or one or more application.

FIG. 17 illustrates a “sort by” feature. Sort feature 126 may be included on dashboard 124 or elsewhere throughout the interactive user interface of the system. To use the sort by feature 126, an application owner may choose to sort the actions, action types, or modules using a “sort by” menu. Though not an exhaustive list, a user can choose to sort by one or more of the following: Name, Ascending 176 (can sort modules alphabetically from A-Z); Name, Descending 178 (can sort modules alphabetically from Z-A); Status, Ascending 180 (modules that are stopped will appear first if “status, ascending” is selected; Status, Descending 182 (modules that are running will appear first if “status, descending” is selected; Schedule, Latest 184 (modules with the earliest activity date will show first if “schedule, latest” is selected; and Schedule, Farthest 186 (modules with the last activity date will show first if “schedule, farthest” is selected).

In an embodiment, one or more sections of the dashboard or user interface, including the main page of the dashboard itself, may include as search bar 122 or smart search option. The search option can allow an application owner to perform various searches, such as searching by page name, application name, or environment name, for example.

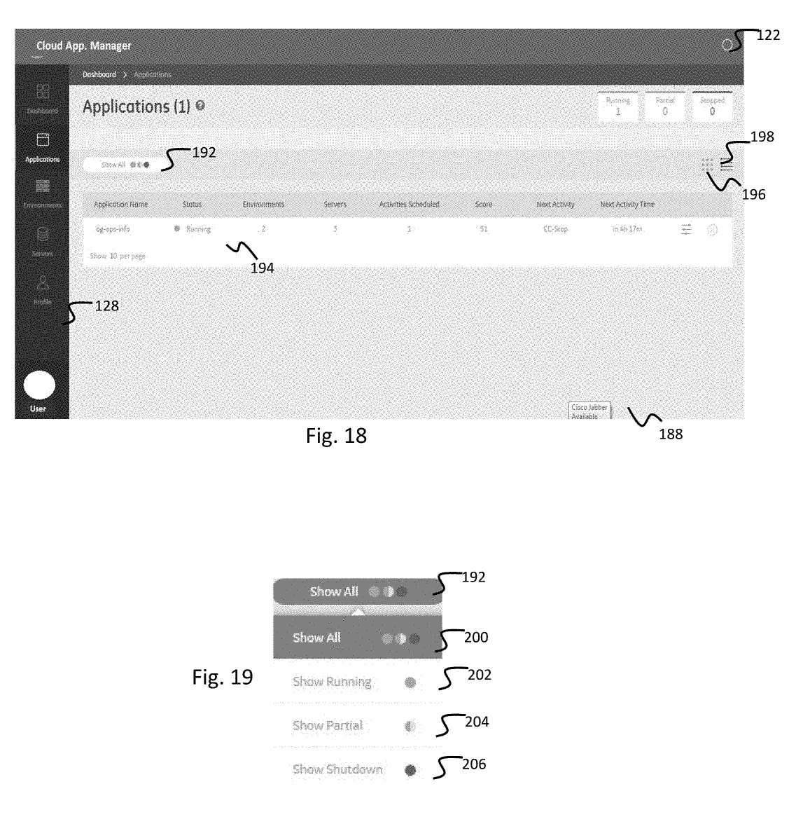

By selecting icon 114 in FIG. 7, an application owner may be brought to or select an applications screen or page 188 illustrated in FIG. 18. From the applications page 188, an application owner can view one or more of the applications 194 the user has access to or has permission to view in the cloud. In an embodiment, additional options may be provided to suit application owner preferences or needs, such as displaying applications in a grid by clicking grid icon 196, which can consist of viewing a certain number of applications in a row by a certain number of applications in a column, for example, 3 applications in a row by 3 applications in a column. An application owner may also choose to list the applications by clicking a list icon 198, which may include details of the applications, such as name, last updated, etc. with details of the applications in a top-to-bottom list format. An application owner can sort such a list by any factor of the application.

In an embodiment, the applications page includes an automation schedule control icon or list similar to or the same as that illustrated in FIGS. 8-12. By selecting the automation schedule, an application owner may view information about the application, such as the name of the application, the environment, the server, the downtime, the number of activities scheduled, the type of activities scheduled, the product, and information about the activities. Information may include what the next scheduled activity is, and/or when the next scheduled activity or activities are scheduled to occur. This can allow an application owner to schedule activities at an application level.

The applications page may include a status menu 192 illustrated in FIG. 18 and FIG. 19. The status menu may use icons, colors, shapes, progress bars, or another tracking element to illustrate to the user the status of application or applications. For instance, in a “show all” view 200, the user can view all applications, “show running” 202 can display applications which only have all running servers, “show partial” 204 can display applications which have running and shutdown servers, and “show shutdown” 206 can display applications which have only shutdown servers. The different views may be shown to the user, for example, using colored circles. In an embodiment, “show running” may be illustrated by a green circle, “show partial” may be illustrated by half green/half yellow circle, “show shutdown” may be illustrated by a red circle, and “show all” may include all three circles illustrating the various stages. As described above, a number of illustrative design features may be chosen based on user or designer preference as needed.

The applications page may also include a search bar 122 or smart search icon. By clicking on the search option, the user can search by page name, application name, environment name, or other identifying criteria. Additionally, the application owner may choose to sort the applications using the same or a “sort by” menu 126 similar to the sort by menu described above.

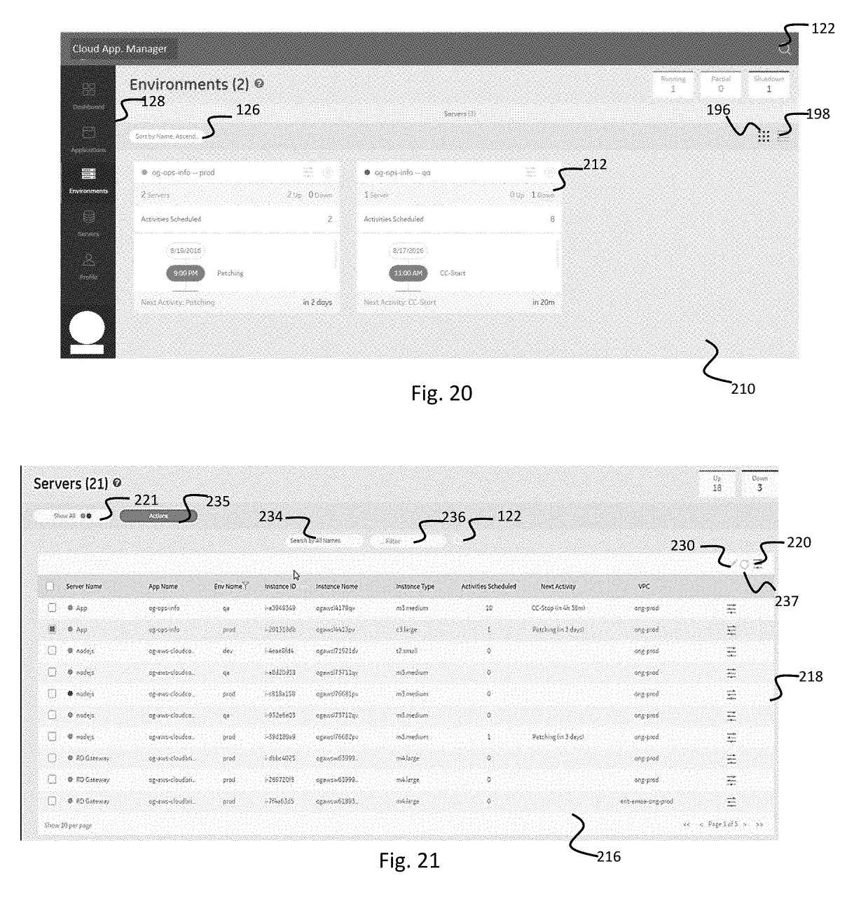

As illustrated in FIG. 20, the system may include an environments screen or page 210, which the application owner may be brought to upon selection of an environments icon 116 or automatically. In an embodiment, the environments page 210 can include all environments of every application 212 and/or selected applications an owner has permission to or can view. When an application owner opens the automation schedule control page, similar to that illustrated in FIGS. 8-12, the application owner may be able to schedule activities at the environment level. In an embodiment, all servers in the environment can include or be updated with a new activity. This environment view may show one or more of the name of the application, the number of servers, the servers that are up, the servers that are down, the number and/or type of activities scheduled, the date the activity may be scheduled, and/or the time the activity may be scheduled. The environments page may also show the next activity that is scheduled and can display the type of activity as well as the time (minutes, hours, days, weeks, months, etc.) until the next activity occurs.

By selecting the servers icon 118 on the module homepage, the application owner may be brought to a servers screen or page 216 as illustrated in FIG. 21. The servers page 216 can contain all or some of the servers an application owner has access to or can view in a list 218, and may include an option to show all running servers, all shutdown servers, or a combination thereof in the show all menu 220. In an embodiment, the servers screen can include an automation schedule control 220 for one or more servers, which may be selectable by an application owner. An application owner may choose to open the automation schedule control 220 for one or more servers, which can open an automation schedule control screen such as that illustrated in FIG. 23. Some servers may not have activities scheduled and may be “read only.” These servers may be illustrated by an icon or other visual cue notifying the user that they are read only.

To schedule an activity for multiple servers, the application owner may select the servers from a list of servers 226. The selection may be performed by highlighting, check boxes, radial buttons, or other selecting means 224. The application owner can then select an automation icon, for example at the top of the table.

In an embodiment, the application owner can choose which columns the user may want to view in the table by opening a column selector feature 230 illustrated in FIG. 21 and FIG. 24. The column selector 230 may be illustrated as an icon, such as a pencil icon, at the top of the table and the user may be able to toggle on or off the columns the user wishes to view using toggle switches 232. In other embodiments, check boxes, highlighting, radial buttons or other selecting means may be used. Based on the application owner preference, for instance, an application owner may choose to view the server name, not view the status, view the application name, view the environment name, view the instance name, and not view the region.

In an embodiment, a search option by attribute or by column may be provided in a search input 234. An application owner may choose, for instance, to search by all names, server name, environment name, application name, instance name, region name, instance type, and/or instance ID. In an embodiment, a user may choose a filter option 236 to filter by the environment name to view more or less environments according to the application owner's preference. A refresh icon 238 may also be included, which can refresh the table of servers and/or clear any filtering or search criteria.

In an embodiment, a quick actions option 238 may also be provided as illustrated in FIG. 21 and FIG. 25. In an embodiment, the quick actions icon 238 may be selected, which can allow the application owner to select and/or perform certain quick actions for one or more server at a time. Exemplary actions may include start, stop, reboot, check status, view snapshots, take a snapshot, view alerts, view uptime, view usage graph, view or add notes. The actions icon 238 can allow a user to choose to activate an action item immediately, in real time, or on demand. A user may choose to view the usage of their system or an instance, for example, to determine the impact of turning servers on and off. This information may be presented graphically or by displaying other data to a user in real time without the need to request the information from another party. The information can allow a user to view monitoring statistics about the health of their instance.

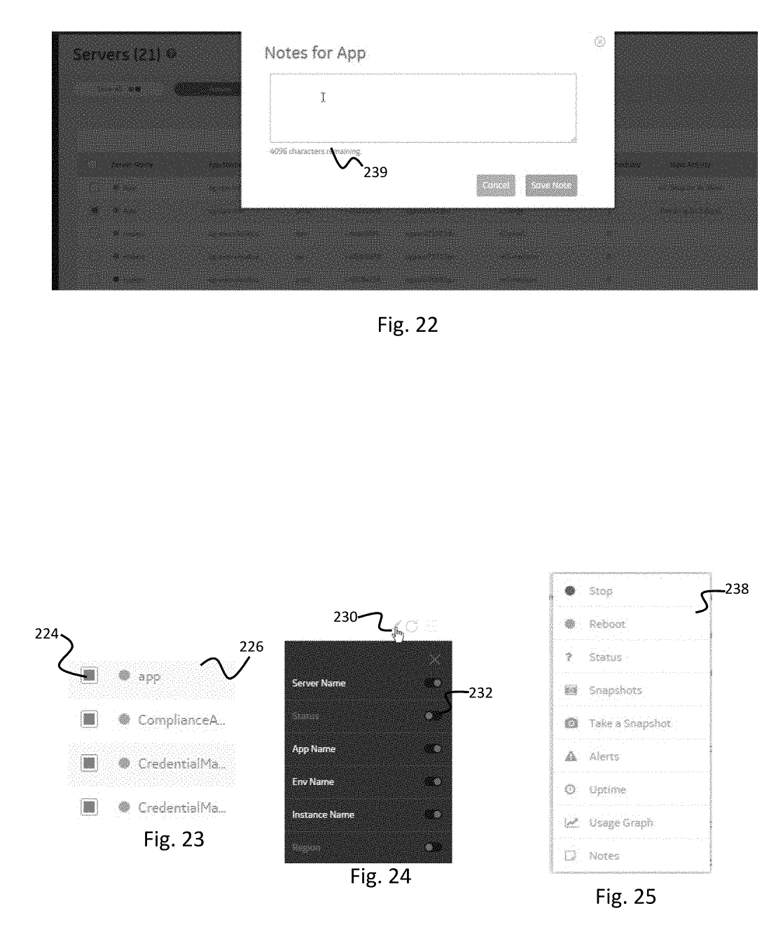

FIG. 22 illustrates a note screen. The environments page or screen 242 may include an option for an owner or their delegate to provide notes about an instance. In an exemplary embodiment, a note box 239 can allow a user to type in, save, and edit notes about an instance. The notes about an instance can be, for example, a description of an instance, its status, proposed actions, or past actions, to be stored for future reference, to provide a history of the application, and/or to share information among multiple users of the system. A notes feature similar to that illustrated in 239 may be employed elsewhere in the module 100.

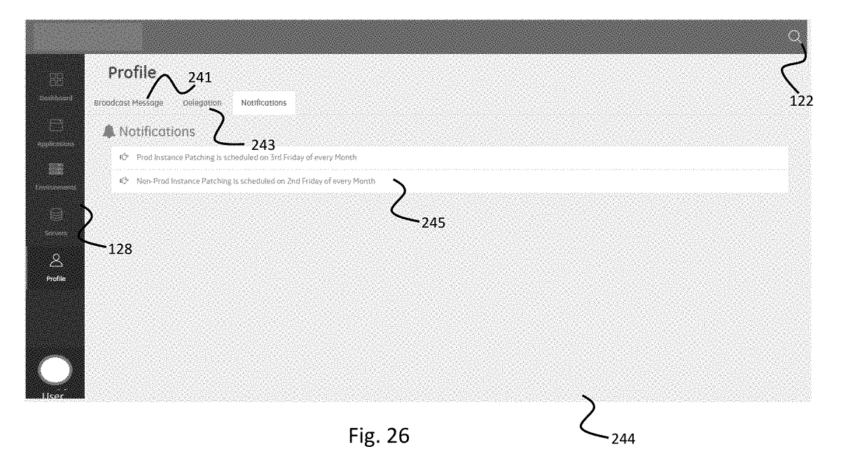

An application owner may also select a profile page icon 120 in FIG. 7 which can bring an application owner to a profile page or screen 244 as illustrated in FIG. 26. The profiles page 244 provides a user with a list of notifications 242 specific to the user for which the user's attention can be drawn to or which require a user's action. Other notifications may also be present. A user may also view and/or update one or more broadcast messages by selecting 241 or view and/or update which individuals or groups have access to the module 100 by selecting 243.

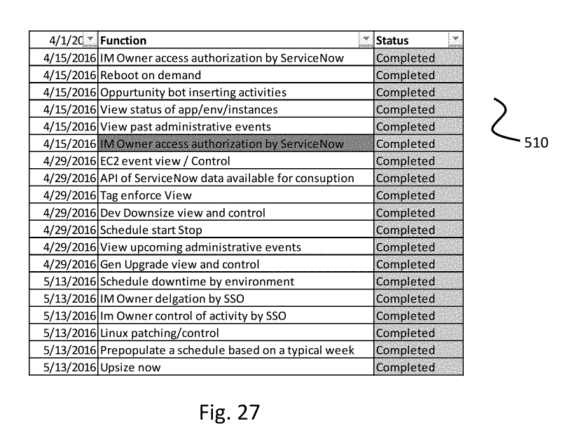

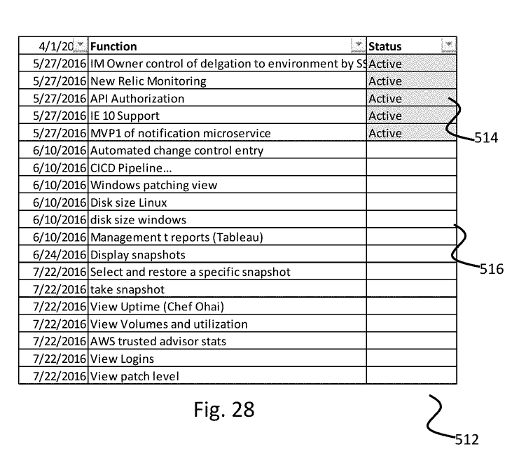

As illustrated in FIG. 27 and FIG. 28, the system may also generate a report or list of activities. This list may include those activities which were scheduled to occur and have been completed as shown in chart 510 of FIG. 27. The same list 510 or a separate list shown in FIG. 28 at chart 512 may also show which activities are active 514 and which activities are scheduled but have not begun 516. This report or list can allow an application owner or their delegates to monitor activities that have been completed, are in progress, or that have been completed for their application.

Other embodiments are within the scope and spirit of the disclosed subject matter. The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor can receive instructions and data from a read-only memory or a random access memory or both. The essential elements of a computer are a processor for executing instructions and one or more memory devices for storing instructions and data. Generally, a computer can also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having one or more display devices, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method for application management comprising:
identifying, using a module, a list of applications;
inserting one or more automation schedules for one or more applications of the list of applications into a database;
running the one or more automation schedules;
identifying one or more instance activity;
scheduling a time for the one or more instance activity to occur; and
sending a notification to an application user, wherein the notification alerts a user to the scheduled time for the one or more instance activity.

2. The method of claim 1, wherein the one more scheduled instance activity proceeds automatically.

3. The method of claim 1, wherein, in the module, the user changes the scheduled time for the one or more instance activity.

4. The method of claim 3, wherein the one or more instance activity proceeds at the time scheduled by the user.

5. The method of claim 1, wherein the notification is an email.

6. The method of claim 1, wherein module has limited access.

7. The method of claim 1, wherein the time scheduled by the module is based upon historic data.

8. A method of application management by a user, comprising:
identifying an instance to change;
entering a module for application management;
viewing, in the module, a list of one or more activities;
choosing one or more activities to run.

9. The method of claim 8, wherein the module proposes a time to run the one or more activities.

10. The method of claim 8, wherein a user selects a time to run the one or more activities.

11. The method of claim 9, wherein the one or more activities is automatically run at the proposed time.

12. The method of claim 10, wherein the one or more activities is automatically run at the selected time.

13. An application management system comprising:
an application management module, wherein the application management module comprises:
a dashboard comprising one or more selectable elements for management of one or more applications,
wherein application management comprises scheduling and notifying a user of one or more instance activity.

14. The system of claim 13, wherein the application management module displays a list of one or more instances associated with the one or more applications.

15. The system of claim 13, wherein the dashboard is customizable by a user.

16. The system of claim 13, wherein the dashboard further comprises a cost section.

17. The system of claim 13, wherein the system determines a time for running the one or more instance activity.

18. The system of claim 13, wherein a user selects a time for the one or more instance activity.

19. The system of claim 13, wherein the one or more instance activity runs automatically.

20. The system of claim 13, wherein the system proposes a time for running the one or more instance activity and a user changes the time of the one or more instance activity to a different time.
